(19) United States
(12) Patent Application Publication
(10) Pub. No.: US 2008/0213650 A1
(43) Pub. Date: Sep. 4, 2008

(54) Microstructures and Methods of Fabrication Thereof

(75) Inventors: Paul A. Kohl, Atlanta, GA (US); Christopher W. Moore, Atlanta, GA (US); Jun Li, Atlanta, GA (US)

Correspondence Address: STOEL RIVES LLP - SLC, 201 SOUTH MAIN STREET, ONE UTAH CENTER, SALT LAKE CITY, UT, 84111, US

(73) Assignee: GEORGIA TECH RESEARCH CORPORATION, Atlanta, GA (US)

(21) Appl. No.: 10/590,264

(22) PCT Filed: Feb. 16, 2005
(86) PCT No.: PCT/US2005/005088

§ 371 Date: Jan. 16, 2008

Related U.S. Application Data
(60) Provisional application No. 60/545,772, filed on Feb. 19, 2004.

(51) Int. Cl. H01M 4/92; H01M 4/90; H01M 8/02; B05D 1/00

(52) U.S. Cl. 429/40; 429/12; 427/126.3; 427/58

(57) ABSTRACT

Fuel cells, fuel cell membranes, micro-fuel cells, and methods of fabricating each, are disclosed. One exemplary fuel cell, among others, includes a membrane including a material such as organic conducting materials and inorganic conducting materials, and combinations thereof. The membrane has a thickness of about 0.01 to 10 μm, and has an area resistivity of about 0.1 to 1000 ohms cm².

### CLAIM OF PRIORITY TO RELATED APPLICATION

This application claims priority to co-pending U.S. provisional application entitled “Thin-Film Membranes For Fuel Cells” having Ser. No. 60/545,772, filed on Feb. 19, 2004, which is entirely incorporated herein by reference.

### STATEMENT REGARDING FEDERALLY SPONSORED RESEARCH OR DEVELOPMENT

The U.S. government may have a paid-up license in this invention(s) and the right in limited circumstances to require the patent owner to license others on reasonable terms as provided for by the terms of MDA awarded by DARPA (Grant # F33615-01-1-2173) of the U.S. Government.

### TECHNICAL FIELD

The present invention(s) is generally to related fuel cells, and, more particularly, is related to fuel cell membranes, micro-fuel cells, and methods of making fuel cell membranes and micro-fuel cells.

### BACKGROUND

Portable electronic devices, including those for mobile communications, microsensors, micro-electromechanical systems (MEMS), and microfluidic devices will benefit from advances in energy storage. The availability of power sources with higher energy density and lower cost will enable a wider range of usage and functionality. One possible higher energy density source is the fuel cell.

For electronic devices with small power requirements, microfabricated power sources, including fuel cells, are being investigated. Issues to consider include reducing size and weight, improving signal integrity with fewer interconnects, increasing processing efficiency, and lowering cost.

Some fuels of interest in micro-fuel cells for devices include hydrogen, methanol, and other hydrocarbons (e.g., ethylene glycol or formic acid). Hydrogen fuel cells and direct methanol fuel cells (DMFCs) operate at relatively low temperature (e.g., ambient to 120° C.). They employ a solid proton exchange membrane (PEM) to transport the protons from the anode to the cathode. Hydrogen can be stored as a pressured gas or in a metal hydride form. It requires humidification for high membrane conductivity.

A methanol-water mixture can be oxidized at the anode in either liquid or vapor form. Methanol is an attractive fuel because it can be stored as a liquid, is inexpensive, and has a high specific energy. Compared with other fuel cell systems, the liquid-feed DMFC is relatively simple and could be easily miniaturized since it does not need a fuel reformer, complicated humidification, or thermal management system. Furthermore, methanol has a high energy density in comparison with lithium polymer and lithium ion polymer batteries.

Proton exchange membranes can be used in low-temperature fuel cells that operate with either hydrogen or methanol. The solid membrane in conventional fuel cells is usually a perfluorinated polymer with sidechains terminating in sulfonic acid moieties, such as Nafion. Membranes in PEM fuel cells generally contain water to keep the conductivity high. Methanol crossover causes a mixed potential and poisoning of the oxygen reduction reaction, leading to decreased performance. Therefore, there is a need in the industry to overcome at least some of the aforementioned inadequacies and deficiencies.

### SUMMARY

Briefly described, embodiments of this disclosure, among others, include fuel cells, fuel cell membranes, micro-fuel cell, and methods of fabricating each. One exemplary fuel cell, among others, includes a membrane including a material such as organic conducting materials, inorganic conducting materials, and combinations thereof. The membrane has a thickness of about 0.01 to 10 μm, and has an area resistivity of about 0.1 to 1000 ohms cm².

One exemplary micro-fuel cell, among others, includes a substrate having anode current collectors disposed thereon; a membrane disposed on the anode current collectors, wherein the membrane includes a material such as silicon dioxide, doped silicon dioxide, silicon nitride, silicon oxynitride, metal oxides, metal nitrides, metal oxynitirdes, and combinations thereof, wherein the membrane has a thickness of about 0.01 to 10 μm, and wherein the membrane has an area resistivity of about 0.1 to 1000 ohms cm²; a hollow channel substantially defined by a portion of the substrate and a portion of the membrane, wherein at least one catalyst layer is exposed to the channel, wherein the anode current collector is disposed adjacent the channel; a cathode current collector disposed on the membrane on the side opposite the substrate; wherein there is an electrically conductive path between the catalyst layer and the anode current collector.

Methods of fabricating a micro-fuel cell are also provided. One exemplary method includes, among others: providing a substrate having an anode current collector disposed thereon; disposing a sacrificial polymer layer onto the substrate and the anode current collector; removing portions of the sacrificial material not disposed on the anode current collector to form sacrificial material portions; disposing a first porous catalyst layer onto the sacrificial material portions; disposing a layer of a membrane material onto the sacrificial material portions, the first porous catalyst layer, and the anode current collector; and removing the sacrificial material portions to form hollow channels substantially defined by the substrate, membrane material, and the first porous catalyst layer. The membrane material includes silicon dioxide, doped silicon dioxide, silicon nitride, silicon oxynitride, metal oxides, metal nitrides, metal oxynitrides, and combinations thereof.

Another exemplary method includes, among others: providing a substrate having an anode current collector disposed thereon; disposing a sacrificial polymer layer onto the substrate and the anode current collector; removing portions of the sacrificial material not disposed on the anode current collector to formed sacrificial material portions; disposing a first porous catalyst layer onto the sacrificial material portions; disposing a layer of a membrane material onto the sacrificial material portions, the first porous catalyst layer, and the anode current collector, wherein the membrane material includes silicon dioxide, doped silicon dioxide, silicon nitride, silicon oxynitride, metal oxides, metal nitrides, metal oxynitrides, and combinations thereof; and removing the sacrificial material portions to form hollow channels substantially defined by the substrate, membrane material, and the first porous catalyst layer.

Another exemplary method includes, among others: providing a substrate having an anode current collector disposed thereon and a catalyst layer disposed thereon, wherein the anode current collector and the catalyst layer are adjacent one another; disposing a sacrificial polymer layer onto the substrate, the anode current collector, and the catalyst layer; removing portions of the sacrificial material not disposed on the anode current collector to form sacrificial material portions disposed on the catalyst layer; disposing a layer of a membrane material onto the sacrificial material portions and the anode current collector, wherein the membrane material includes silicon dioxide, doped silicon dioxide, silicon nitride, silicon oxynitride, metal oxides, metal nitrides, metal oxynitrides, and combinations thereof; and removing the sacrificial material portions to form hollow channels substantially defined by the substrate, membrane material, and the catalyst layer.

Other structures, systems, methods, features, and advantages will be, or become, apparent to one with skill in the art upon examination of the following drawings and detailed description. It is intended that all such additional structures, systems, methods, features, and advantages be included within this description, be within the scope of the present disclosure, and be protected by the accompanying claims.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principles of this disclosure. Moreover, in the drawings, like reference numerals designate corresponding parts throughout the several views.

FIG. 1 illustrates a cross-sectional view of a representative fuel cell membrane.

FIG. 2 illustrates a cross-sectional view of another representative fuel cell membrane.

FIGS. 3A through 3D illustrate four embodiments of micro-fuel cells.

FIGS. 4A through 4H are cross-sectional views that illustrates a representative method of fabricating the micro-fuel cell illustrated in FIG. 3A.

FIG. 5 is an XPS scan of sputtered platinum/ruthenium (Pt/Ru).

FIG. 6 is a plot of the measured and calculated resistances for sputtered platinum films.

FIG. 7 is a plot of the ionic conductivity of SiO₂ films measured through impedance spectroscopy.

FIG. 8 is a plot of a half-cell performance of microchannels with humidified hydrogen.

FIG. 9 is a plot of a half-cell performance of microchannels with methanol-water and acid-methanol-water solutions.

FIG. 10 is a plot of a micro-fuel cell performance with sputtered anode and cathode.

FIG. 11 is a plot of a micro-fuel cell performance of sample B at different temperatures.

FIG. 12 is a plot of ambient temperature micro-fuel cell performance of samples B, C, and D with different amounts of sputtered anode catalyst.

FIG. 13 is a plot of current density of the imbedded catalyst sample held at constant potential for about 10 minutes.

FIG. 14 is a plot of a comparison between steady-state (at 10 minutes) and linear voltametry polarization data for sample D with humidified hydrogen at room temperature.

FIG. 15 is a plot of a microchannel fuel cell performance with 1.0 M acidic methanol at 1 mL/hr.

FIG. 16 is a plot of a conductivity of P—SiO₂ films as a function of gas ratio.

FIG. 17 is a plot of a conductivity of P—SiO₂ films as a function of deposition temperature.

FIG. 18 is a plot of a polarization and power curves at room temperature for phosphorous-doped SiO₂ and un-doped SiO₂ samples.

### DETAILED DESCRIPTION

In general, fuel cell membranes, micro-fuel cells, and methods of fabrication thereof are disclosed. Embodiments of the fuel cell membranes are made of silicon dioxide and/or a doped silicon dioxide and relatively thin and have comparable area resistivities as thinker polymer membranes. The thinner the membrane, the easier it is for protons to move through it, thus increasing the amount of electrical current that can be generated. Meanwhile, the materials used to make the membranes are superior to currently used proton exchange membranes (PEMs) in preventing reactants from passing through the membrane, a common problem particularly in direct methanol fuel cells. In addition, the membranes can be fabricated using well-known micro-electronic fabrication techniques. In this regard, the membrane can be fabricated onto the micro-electronic structure to which the fuel cell is going to be used.

In an embodiment, the fuel cell membrane and the micro-fuel cell can be directly integrated into the electronic device. For example, the fuel cell membrane and the micro-fuel cell can be integrated by placing the fuel cell membrane or the micro-fuel cell on the chip, integrating the fuel cell membrane or the micro-fuel cell in the substrate or printed circuit board, and interposing or attaching the fuel cell membrane or the micro-fuel cell to the chip as a separate part that is bonded to the chip.

In general, the fuel cell membranes and micro-fuel cells can be used in technology areas such as, but not limited to, microelectronics (e.g., microprocessor chips, communication chips, and optoeletronic chips), micro-electromechanical systems (MEMS), microfluidics, sensors, and analytical devices (e.g., microchromatography), communication/positioning devices (e.g., beacons and GPS systems), recording devices, and the like.

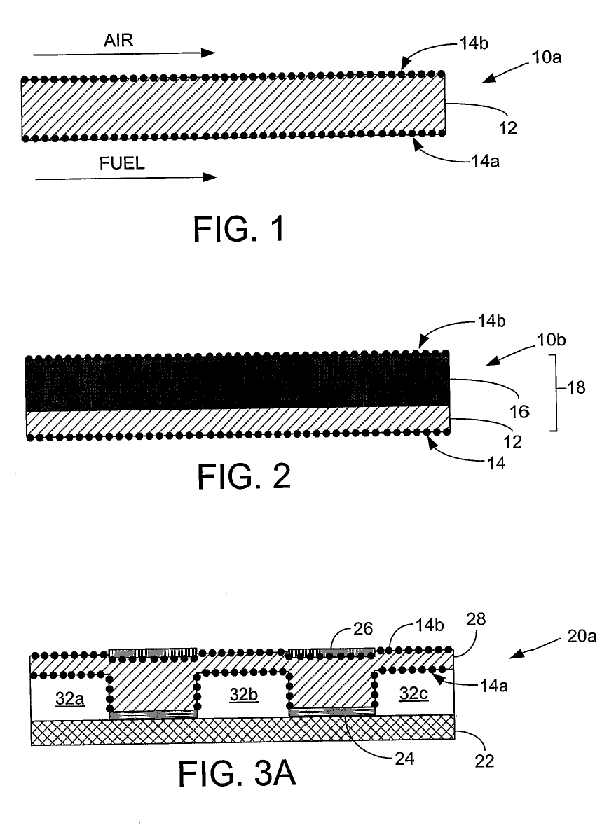

FIG. 1 illustrates a cross-sectional view of a representative fuel cell membrane 10a. The fuel cell membrane 10a includes a membrane 12 (or membrane layer) and a catalyst layer 14a and 14b disposed on each side of the membrane 12. As depicted in FIG. 1, a fuel (e.g., H₂, methanol, formic acid, ethylene glycol, ethanol, and combinations thereof) are contacted with one side of the fuel cell membrane 10a (e.g., on the anode side of the membrane (not shown)), while air is contacted on the opposite side of the fuel cell membrane 10a (e.g., on the cathode side of the membrane (not shown)). For example, the following reactions occur on the anode and cathode side of the fuel cell membrane, respectively, when using methanol: CH₃OH+H₂O→CO₂+6H⁺+6e⁻ and 3/2O₂+6H⁺+6e⁻→3H₂O.

The membrane can include materials such as, but not limited to, organic conducting materials and inorganic conducting materials. For example, the membrane can include material such as, but not limited to, silicon dioxide, doped silicon dioxide, silicon nitride, doped silicon nitride, silicon oxynitride, doped silicon oxynitride, metal oxides (e.g., titanium oxide, tungsten oxide), metal nitrides (e.g., titanium nitride), doped metal oxides, metal oxynitirdes (e.g., titanium oxynitride), doped metal oxynitrides, and combinations thereof. In general, the membranes can be doped with about 0.1 to 20% of dopant in the membrane and about 0.1 to 5% of dopant in the membrane.

The doped silicon dioxide can include, but is not limited to, phosphorous doped silicon dioxide, boron doped silicon dioxide, aluminum doped silicon dioxide, arsenic doped silicon dioxide, and combinations thereof. In general, the doping causes atomic scale defects such as M-OH (M is a metal) and distort the lattice so that protons can be transported therethrough. The amount of doping can be from 0.1 to 20% by weight of dopant in membrane, 0.5 to 10% by weight of dopant in membrane, and 2 to 5% by weight of dopant in membrane.

The membrane 12 has a thickness of less than about 10 micrometers (μm), about 0.01 to 10 μm, about 0.1 to 5 μm, about 0.1 to 2 μm, about 0.5 to 1.5 μm, and about 1 μm. The length of the membrane 12 can be from about 0.001 m to 100 m, and the width can be from about 1 μm to 1000 μm. It should be noted that the length and width are dependent on the application and can be adjusted accordingly.

The membrane 12 has an area resistivity of about 0.1 to 1000 ohms cm², about 0.1 to 100 ohms cm², about 0.1 to 10 ohms cm², about 1 to 100 ohms cm², and about 1 to 10 ohms cm². The area resistivity is defined as the resistivity across the area of the membrane exposed to the fuel (e.g., resistance times area or resistivity times thickness).

The membranes 12 can be formed using methods such as, but not limited to, spin-coating, plasma enhanced chemical vapor deposition (PECVD), screen printing, doctor blading, spray coating, roller coating, meniscus coating, and combinations thereof.

The catalyst layer 14a and 14b can include a catalyst such as, but not limited to, platinum, platinum/ruthenium, nickel, palladium, alloys of each, and combinations thereof. In general, in one embodiment a platinum catalyst is used when the fuel is hydrogen and in another embodiment a platinum/ruthenium catalyst is used when the fuel is methanol. The catalyst layer 14a and 14b can include the same catalyst or a different catalyst. The catalyst layer 14a and 14b is typically a porous catalyst layer that allows protons to pass through the porous catalyst layer. In addition, there is an electrically conductive path between the catalyst layer and the anode current collector.

The catalyst layer 14a and 14b can have a thickness of less than 1μ, about 0.01 to 100 μm, about 0.1 to 5 μm, and about 0.3 to 1 μm.

The catalyst layer 14a and 14b can include alternative layering of catalyst and the membrane material, which builds a thicker catalyst layer 14a and 14b (e.g., two or more layers). For example, two layers improve the oxidation rate of the fuel. This is advantageous because it can increase the anode catalyst loading and keep the catalyst layer porous. The high surface area will allow a high rate of oxidation of the fuel. A higher rate corresponds to higher electrical current and power.

The membrane can be further processed by post-doping. The dopants can be diffused or implanted into the membrane to increase the ionic conductivity. The dopants can include, but are not limited to, boron and phosphorous. Each dopant can be individually diffused into the membrane from a liquid or from a solid source, or can be ion implanted using a high voltage ion accelerator. The conductivity of the membrane can be increased by diffusion of acidic compounds (e.g., carboxylic acids (in the form of acetic acid and trifluoracetic acid) and inorganic acids such as phosphoric acid and sulfuric acid) into the membrane.

FIG. 2 illustrates a cross-sectional view of a representative fuel cell membrane 10b. The fuel cell membrane 10b includes a composite membrane 18 and a catalyst layer 14a and 14b. The composite membrane 18 includes two membrane layers 12 and 16 (polymer layer 16). In another embodiment, the fuel cell membrane 10b can include three or more layers. One catalyst layer 14a is disposed on the polymer layer 16, while the second catalyst layer 14b is disposed on the membrane layer 12. The membrane layer 12 and the catalyst layers 14a and 14b are similar to those described in reference to FIG. 1. In addition, the fuel cell membrane 10b operates in a manner that is the same or similar to, that described above.

Although the membrane layer 12 and polymer layer 16 are separate layers, they both operate as a fuel cell membrane. The combination of properties (e.g., ionic conductivity, fuel crossover resistance, mechanical strength, and the like) of the dual-layer membrane may be superior in some instances than either layer individually. For example, the polymer layer 16 may add additional mechanical support and stability to the membrane layer 12.

In addition, in embodiments where the membrane layer 12 is silicon dioxide, this material is similar to the other insulators being used to fabricate the device, for example, when the membrane 12b is used with a semiconductor device.

The polymer layer 16 can include polymers such as, but not limited to, Nafion™ (perfluorosulfonic acid/polytetrafluoroethylene copolymer), polyphenylene sulfonic acid, modified polyimide, and combinations thereof. For example, when Nafion is used as the polymer layer 16, the open circuit potential has been shown to increase without loss to current density, resulting in an increase in power density and efficiency.

The polymer layer 16 has a thickness of about 1 to 50 μm, 5 to 50 μm, and 10 to 50 μm. The length of the polymer layer 16 can be from about 0.01 μm to 100 m, and the width can be from about 1 μm to 500 μm. It should be noted that the length and width are dependent on the application and can be adjusted accordingly. The polymer can be deposited using techniques such as, but not limited to, spin-coating, and therefore, the polymer can completely cover the substrate, and/or can be selectively deposited into a desired areas.

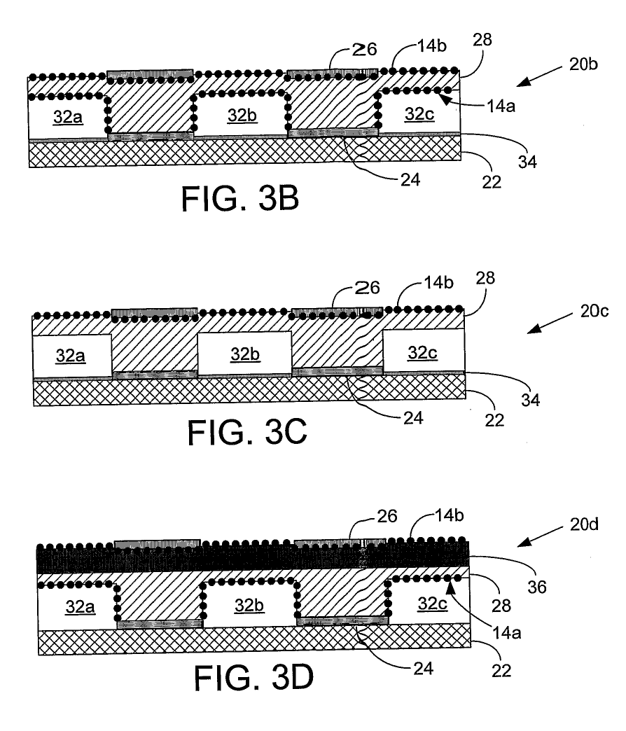

The polymer layer 16 has an area resistivity of about 0.001 to 0.5 ohms cm² FIGS. 3A through 3D illustrate four embodiments of micro-fuel cells 20a, 20b, 20c, and 20d. FIG. 3A illustrates a micro-fuel cell 20a having a membrane 28, a substrate 22, an anode current collector 24, a cathode current collector 26, a first porous catalyst layer 14a, a second catalyst layer 14b, and three channels 32a, 32b, and 32c. The membrane 28 can include the same chemical composition, dimensions, and characteristics, as that described for membrane 12 described above in reference to FIG. 1. The thickness of the membrane 28 is measured from the top of the channels 32a, 32b, and 32c.

The substrate 22 can be used in systems such as, but not limited to, microprocessor chips, microfluidic devices, sensors, analytical devices, and combinations thereof. Thus, the substrate 22 can be made of materials appropriate for the system under consideration (e.g., for printed wiring board, epoxy boards can be used). Exemplar materials include, but are not limited to, glasses, silicon, silicon compounds, germanium, germanium compounds, gallium, gallium compounds, indium, indium compounds, other semiconductor materials and/or compounds, and combinations thereof. In addition, the substrate 12 can include non-semiconductor substrate materials, including any dielectric material, metals (e.g., copper and aluminum), or ceramics or organic materials found in printed wiring boards, for example. Furthermore, the substrate 22 can include one or more components, such as the particular components used in certain systems described above.

The first porous catalyst layer 14a is disposed on the bottom side of the membrane closed to the substrate 22. The second porous catalyst layer 14b is disposed on the top side of the membrane on the side opposite to the substrate 22. The micro-fuel cell 20a includes a first porous catalyst layer 14a and a second porous catalyst layer 14b, which form electrically conductive paths to the anode current collector 24 and the cathode current collector 26, respectively. The first porous catalyst layer 14a and the second porous catalyst layer 14b can include the same catalysts as those described above, and also have the same thickness and characteristics as those described above.

The anode current collector 24 collects electrons through the first porous catalyst layer 14a. The anode current collector 24 can include, but is not limited to, platinum, gold, silver, palladium, aluminum, nickel, carbon, alloys of each, and combinations thereof.

The cathode current collector 26 emits electrons. The cathode current collector 26 can include, but is not limited to, platinum, gold, silver, palladium, aluminum, nickel, carbon, alloys of each, and combinations thereof.

The various anode current collectors 24 and the cathode current collector 26 can be electronically connected in series or parallel, depending on the configuration desired (e.g., the wiring could be from anode-to-cathode (in series) or anode-to-anode (in parallel)). In one embodiment, the individual micro-fuel cells can be connected electronically in series to form fuel cell stacks to increase the output voltage. In another embodiment, the connections can be made in parallel to increase the output current at the rated voltage.

The channels 32a, 32b, and 32c are substantially defined (e.g., bound on all sides in the cross-sectional view) by the membrane 28, the first porous catalyst layer 14a, and the substrate 22. A fuel (e.g., hydrogen and methanol) is flowed into the channels and interacts with the first porous catalyst layer 14a in a manner as described above. The channels 32a, 32b, and 32c, can be in series, parallel, or some combination thereof. The anode current collector 24 is disposed adjacent the channels 32a, 32b, and 32c, but is electrically connected to the porous catalyst layer 14a.

In an embodiment, the channels 32a, 32b, and 32c are formed by the removal (e.g. decomposition) of a sacrificial polymer layer from the area in which the channels 32a, 32b, and 32c are located. During the fabrication process of the structure 20a, a sacrificial polymer layer is deposited onto the substrate 12 and patterned. Then, the membrane 28 is deposited around the patterned sacrificial polymer layer. Subsequently, the sacrificial polymer layer is removed, forming the channels 32a, 32b, and 32c. The processes for depositing and removing the sacrificial polymer are discussed in more detail hereinafter.

Although a rectangular cross-section is illustrated for the channels 32a, 32b, and 32c, the three-dimensional boundaries of the channels can have cross-sectional areas such as, but not limited to, rectangular cross-sections, non-rectangular cross-sections, polygonal cross-sections, asymmetrical cross-sections, curved cross sections, arcuate cross sections, tapered cross sections, cross sections corresponding to an ellipse or segment thereof, cross sections corresponding to a parabola or segment thereof, cross sections corresponding to a hyperbola or segment thereof, and combinations thereof. For example, the three-dimensional structures of the channels, can include, but are not limited to, rectangular structures, polygonal structures, non-rectangular structures, non-square structures, curved structures, tapered structures, structures corresponding to an ellipse or segment thereof, structures corresponding to a parabola or segment thereof, structures corresponding to a hyperbola or segment thereof, and combinations thereof. In addition, the channels can have cross-sectional areas having a spatially-varying height. Moreover, multiple air-regions can be interconnected to form microchannels and microchambers, for example.

The channels 32a, 32b, and 32c height can be from about 0.1 to 100 μm, about 1 to 100 μm, 1 to 50 μm, and 10 to 20 μm. The channels 32a, 32b, and 32c width can be from about 0.01 to about 1000 μm, about 100 to about 1000 μm, about 100 to about 300 μm. The length of the channels 32a, 32b, and 32c can vary widely depending on the application and configuration in which they are used. The channels 32a, 32b, and 32c can be in series, parallel, serpentine, and other configurations that are appropriate for a particular application.

In an embodiment, the sacrificial polymer used to produce the sacrificial material layer can be a polymer that slowly decomposes and does not produce undue pressure build-up while forming the channels 32a, 32b, and 32c within the surrounding materials. In addition, the decomposition of the sacrificial polymer produces gas molecules small enough to permeate the membrane 28. Further, the sacrificial polymer has a decomposition temperature less than the decomposition or degradation temperature of the membrane 28.

The sacrificial polymer can include compounds such as, but not limited to, polynorbornenes, polycarbonates, polyethers, polyesters, functionalized compounds of each, and combinations thereof. The polynorbornene can include, but is not limited to, alkenyl-substituted norbornene (e.g., cyclo-acrylate norbornene). The polycarbonate can include, but is not limited to, norbornene carbonate, polypropylene carbonate, polyethylene carbonate, polycyclohexene carbonate, and combinations thereof.

In addition, the sacrificial polymer can include additional components that alter the processability of the sacrificial polymer (e.g., increase or decrease the stability of the sacrificial polymer to thermal and/or light radiation). In this regard, the components can include, but are not limited to, photoinitiators and photoacid initiators.

The sacrificial polymer can be deposited onto the substrate using techniques such as, for example, spin coating, doctor-blading, sputtering, lamination, screen or stencil-printing, melt dispensing, evaporation, CVD, MOCVD, and/or plasma-based deposition systems.

The thermal decomposition of the sacrificial polymer can be performed by heating to the decomposition temperature of the sacrificial polymer and holding at that temperature for a certain time period (e.g., 1-2 hours). Thereafter, the decomposition products diffuse through the membrane 28 leaving a virtually residue-free hollow structure (channels 32a, 32b, and 32c).

FIG. 3B illustrates a micro-fuel cell 20b having a membrane 28, a substrate 22, an anode current collector 24, a cathode current collector 26, a first porous catalyst layer 14a, a second catalyst layer 14b, a catalyst layer 43, and three channels 32a, 32b, and 32c. The membrane 28 can include the same chemical composition, dimensions, and characteristics, as that described for membrane 12 described above in reference to FIG. 1. The thickness of the membrane 28 is measured from the top of the channels 32a, 32b, and 32c.

The substrate 22, the anode current collector 24, the cathode current collector 26, the first porous catalyst layer 14a, the second catalyst layer 14b, and the three channels 32a, 32b, and 32c are similar to those described above in reference to FIG. 3A.

The catalyst layer 43 is disposed on the substrate 12 within each of the channels 32a, 32b, and 32c. In another embodiment, the catalyst layer 42 can be disposed in less than all of the channels, which is determined by the micro-fuel cell configuration desired. The catalyst layer 43 can be a porous layer or can be a large surface area layer. The catalyst layer 43 can cover the entire portion of the substrate that would otherwise be exposed to the fuel in the channels 32a, 32b, and 32c, or cover a smaller area, as determined by the configuration desired. The catalyst layer 43 can include catalyst such as, but not limited to, platinum, platinum/ruthenium, nickel, palladium, alloys of each, and combinations thereof.

FIG. 3C illustrates a micro-fuel cell 20c having a membrane 28, a substrate 22, an anode current collector 24, a cathode current collector 26, a second catalyst layer 14b, a catalyst layer 43, and three channels 32a, 32b, and 32c. The membrane 28 can include the same chemical composition, dimensions, and characteristics, as that described for membrane 12 described above in reference to FIG. 1. The thickness of the membrane 28 is measured from the top of the channels 32a, 32b, and 32c.

The substrate 22, the anode current collector 24, the cathode current collector 26, the second catalyst layer 14b, the catalyst layer 43, and the three channels 32a, 32b, and 32c are similar to those described above in reference to FIGS. 3A and 3B.

In this embodiment, the micro-fuel cell 20c does not include a first porous catalyst layer, however, the catalytic reaction and activity can be created by the catalyst layer 43.

FIG. 3D illustrates a micro-fuel cell 20d having a membrane 28, a substrate 22, an anode current collector 24, a cathode current collector 26, a first catalyst layer 14a, a second catalyst layer 14b, and three channels 32a, 32b, and 32c. The membrane 28 can include the same chemical composition, dimensions, and characteristics, as that described for membrane 12 described above in reference to FIG. 1. The thickness of the membrane 28 is measured from the top of the channels 32a, 32b, and 32c.

The polymer layer 36 is disposed on the top side of the membrane 28 opposite the substrate 22. The second porous catalyst layer 14b and the cathode current collector 26 are disposed on the top side of the polymer layer 36 on the side opposite the membrane 28.

The substrate 22, the anode current collector 24, the cathode current collector 26, the second catalyst layer 14b, first catalyst layer 14a, and the three channels 32a, 32b, and 32c are similar to those described above in reference to FIGS. 3A and 3B. It should be noted that a catalyst layer as described in FIGS. 3B and 3C can be included in an embodiment similar to micro-fuel cell 20d.

The polymer layer 36 is similar that the polymer layer 16 described in FIG. 2. The polymer layer 36 can include the same polymers as described in reference to FIG. 2, and also include the same dimensions. In addition, the dimensions are partially limited to the overall dimensions of the micro-fuel cell 20d and the dimensions of the membrane 28.

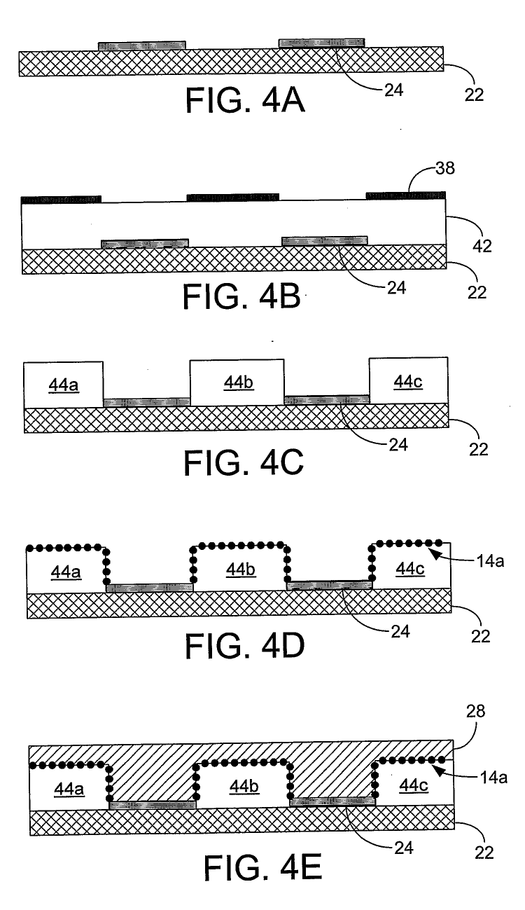

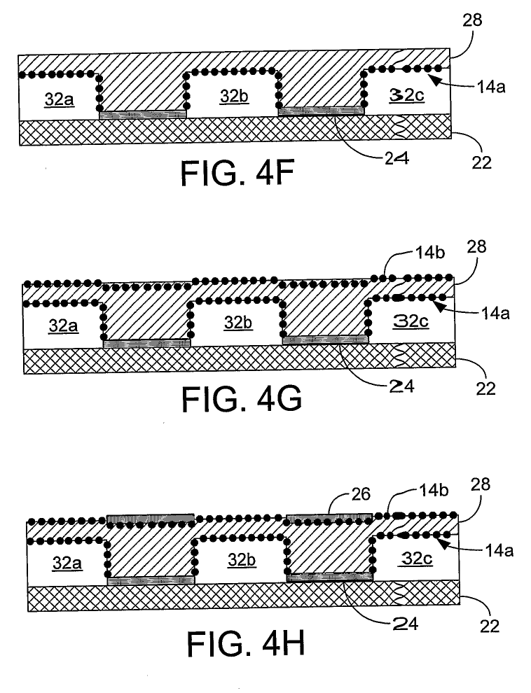

Now having described the structure 10 having micro-fuel cells 20a, 20b, 20c, and 20d in general, the following describes exemplar embodiments for fabricating the micro-fuel cell 20a, which could be extended to fabricate micro-fuel cells 20b, 20c, and 20d. It should be noted that for clarity, some portions of the fabrication process are not included in FIGS. 4A through 4H. As such, the following fabrication process is not intended to be an exhaustive list that includes all steps required for fabricating the micro-fuel cell 20a. In addition, the fabrication process is flexible because the process steps may be performed in a different order than the order illustrated in FIGS. 4A through 4H, or some steps may be performed simultaneously.

FIGS. 4A through 4H are cross-sectional views that illustrate a representative method of fabricating the micro-fuel cell 20a illustrated in FIG. 3A. It should be noted that for clarity, some portions of the fabrication process are not included in FIGS. 4A through 4H. As such, the following fabrication process is not intended to be an exhaustive list that includes all steps required for fabricating the micro-fuel cell 20a. In addition, the fabrication process is flexible because the process steps may be performed in a different order than the order illustrated in FIGS. 4A through 41H and/or some steps may be performed simultaneously.

FIG. 4A illustrates the substrate 22 having an anode current collector 24 disposed thereon. FIG. 4B illustrates the formation of the sacrificial material layer 42 on the substrate 22 and the anode current collector 24. The sacrificial polymer layer 22 can be deposited onto the substrate 10 using techniques such as, for example, spin coating, doctor-blading, sputtering, lamination, screen or stencil-printing, melt dispensing, CVD, MOCVD, and/or plasma-based deposition systems. In addition, a mask 38 is disposed on the sacrificial material layer 42 to remove portions of the sacrificial material layer 42 to expose the anode current collector 24. FIG. 4C illustrates the removal of portions of the sacrificial material layer 42 to form sacrificial portions 44a, 44b, and 44c.

FIG. 4D illustrates the formation of the first porous catalyst layer 14a on the sacrificial portions 44a, 44b, and 44c. The first porous catalyst layer 14a can be formed by sputtering, evaporation, spraying, painting, chemical vapor deposition and combinations thereof.

FIG. 4E illustrates the formation of the membrane layer 28 on the porous catalyst layer 14a, the sacrificial portions 44a, 44b, and 44c, and the anode current collectors 24. The membrane can be formed using methods such as, but not limited to, spin-coating, plasma enhanced chemical vapor deposition (PECVD), chemical vapor deposition, sputtering, evaporation, laser ablation deposition, and combinations thereof. The temperature at which the membrane 28 is formed should be from about 25 to 400° C., about 50 to 200° C., or about 100 to 150° C. It should be noted that temperature is limited to the range at which the other materials are stable (e.g., decomposition temperature).

FIG. 4F illustrates the removal of the sacrificial portions 44a, 44b, and 44c to form the channels 32a, 32b, and 32c. The sacrificial portions 44a, 44b, and 44c can be removed using thermal decomposition, microwave irradiation, uv/visible irradiation, plasma exposure, and combinations thereof. It should be noted that the sacrificial portions 44a, 44b, and 44c can be removed at a different step in the fabrication process, such as after the step illustrated in FIG. 4G and/or FIG. 4H.

FIG. 4G illustrates the formation of the second porous catalyst layer 14b on the sacrificial portions 44a, 44b, and 44c. The second porous catalyst layer 14b can be formed by sputtering, evaporation, spraying, painting, chemical vapor deposition, and combinations thereof.

FIG. 4H illustrates the formation of the cathode current collector 26 on the second porous catalyst layer 14b and the membrane 28.

As mentioned above, a step can be added between the steps illustrated in FIGS. 4F and 4G to add a polymer layer as shown in FIG. 2 and FIG. 3D, and the second porous catalyst layer and the cathode current collector can be formed on the polymer layer. The polymer layer can be formed by methods such as, but not limited to, spin coating, doctor-blading, sputtering, lamination, screen or stencil-printing, melt dispensing, CVD, MOCVD, and plasma-based deposition systems. Likewise, the step of adding the first porous catalyst layer 14a can be omitted to form the micro-fuel cell 20c illustrated in FIG. 3C. In addition, the catalyst layer 34 (for FIGS. 3B and 3C) can be disposed at some step prior to forming the membrane layer.

### EXAMPLE 1

Microfabricated fuel cells have been designed and constructed on silicon integrated circuit wafers using many processes common in integrated circuit fabrication, including sputtering, polymer spin coating, reactive ion etching, and photolithography. Proton exchange membranes (PEM) have been made by low-temperature, plasma-enhanced chemical vapor deposition (PECVD) of silicon dioxide. Fuel delivery channels were made through the use of a patterned sacrificial polymer below the PEM and anode catalyst. Platinum-ruthenium catalyst was deposited by DC sputtering. The resistivity of the oxide films was higher than traditional polymer electrolyte membranes (e.g., Nafion™) but they were also much thinner.

### Experimental Method

The design and fabrication of the micro-fuel cells is based on a technique of using a sacrificial polymer to form the fuel delivery channels for the anode. This sacrificial polymer, Unity 2000P (Promerus LLC, Brecksville, Ohio), was patterned by ultraviolet exposure and thermal decomposition of the exposed areas. The membrane and electrodes coat the patterned features in a sequential buildup process. One of the last steps in the fabrication sequence is the thermal decomposition of the patterned Unity features, leaving encapsulated microchannels (e.g., similar to process shown in FIGS. 4A through 4H). Unity decomposition took place in a Lindberg tube furnace with a steady nitrogen flow. The final decomposition temperature and time was about 170° C. for about 1.5 hours. The micro fuel cell fabrication included deposition of catalytic electrodes and current collectors before and after the encapsulating material, which served as the PEM, was deposited. A schematic cross section of the device built on an array of parallel microchannels is shown in FIG. 3A.

Silicon dioxide was used as the encapsulating material and PEM. The deposition of SiO₂ took place in a Plasma-Therm PECVD system (Plasma-Therm, St. Petersburg, Fla.) at temperatures of 60-200° C. The reactant gases were silane and nitrous oxide with a N₂O:SiH₄ ratio of 2.25 and operating pressure of 600 mTorr. Deposition times of 60-75 minutes produced film thicknesses, measured with an Alpha-Step surface profilometer (KLA-Tencor, San Jose, Calif.), between 2.4 and 3.4 μm.

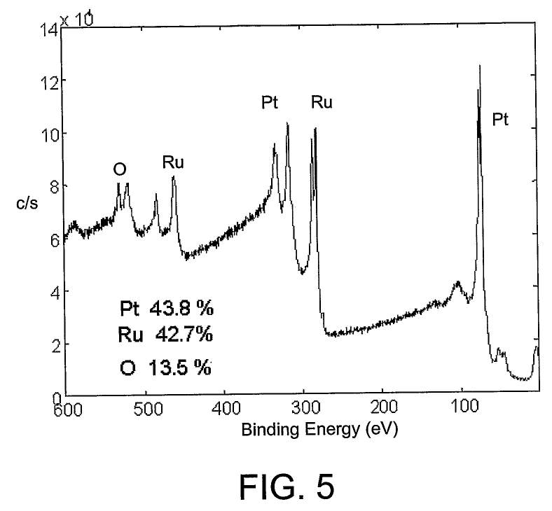

The catalyst layers were sputter deposited using a CVC DC sputterer (CVC Products, Inc., Rochester, N.Y.). A 50:50 atomic ratio platinum/ruthenium target (Williams Thin-Film Products, Brewster, N.Y.) was used as the source target. FIG. 5 shows an X-ray photoelectron spectroscopy (XPS) scan confirming that the sputtered films have equal amounts of the two metals. Porous films with average thicknesses of about 50-200 Å were deposited on the sacrificial polymer, and then coated with the membrane, to serve as anode catalysts. In addition, an about 600 Å thick layer of Pt/Ru was deposited on the bottom of the anode microchannels opposite the membrane to serve as both additional catalyst and for current collection. This additional catalyst improved the performance of the microchannel fuel cells, particularly when using acidic methanol.

Porous catalytic cathodes were also fabricated by sputtering of Pt or Pt/Ru on the top, or outside, of the PEM. However, the cathodes on some samples were made by painting a prepared catalyst ink containing carbon-supported Pt in Nafion™ on the PEM, followed by coating with a porous gold current collector. This thick-film approach increased the catalyst loading and performance on the cathode side of the PEM. This was especially useful in studying the anode performance by eliminating the oxygen reduction at the cathode from being the rate-limiting step.

All electrochemical measurements, including impedance spectroscopy (IS) and linear voltamagrams, were performed with a PerkinElmer PARSTAT 2263 (EG&G, Princeton, N.J.) electrochemical system. The scan rate for linear sweep voltametry was 1 mV/s. Ionic conductivity was measured with impedance spectroscopy through SiO₂ films deposited onto aluminum-coated substrates and contacted with a mercury probe, as well as with actual cells. The frequency range for the impedance measurement was from 100 mHz to 1 MHz, with an AC signal amplitude of 10 mV. Half-cell devices were fabricated with the fuel delivery channels and sputtered catalyst under the SiO₂ PEM. Instead of a cathode, epoxy was used to form a well on top of the devices and filled with a 1 M sulfuric acid solution. Measurements were made with a saturated calomel electrode (SCE) and a Pt wire as the reference and counter electrodes, respectively, placed in the sulfuric acid solution. A PHD 2000 Programmable Syringe Pump (Harvard Apparatus, Holliston, Mass.) delivered liquid fuels and controlled the flow rates. Hydrogen was supplied with a pressurized tank of ultra high purity grade gas that passed through a bubbler to humidify the feed.

### Results and Discussion

Microfabricated fuel cells were successfully fabricated using many materials and processes common to integrated circuit fabrication. The performance of the micro-fuel cells with different fuels and temperatures was measured for cells with different features, including half-cells and full cells. The purpose was to investigate the individual fuel cells components (e.g., anode, cathode, and PEM) as a function of processing conditions.

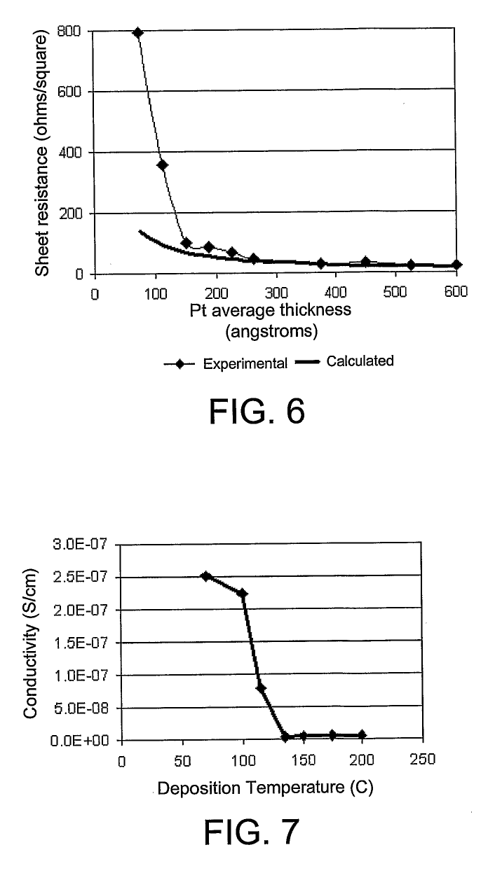

In addition to catalytic activity, the key properties that were desired for the sputtered catalyst layers were porosity and electrical conductivity. The catalyst layer that contacts the membrane must be porous so that the protons generated during oxidation can come in contact with the PEM and pass to the cathode. The electrons generated at the anode catalyst need a path to the metal current collectors. Different amounts of Pt were sputtered onto substrates containing two solid electrodes patterned on opposite sides of an insulator. The sheet resistance of the Pt layers across the space between the electrodes was measured. FIG. 6 shows the measured resistance (Q/square) of sputtered Pt films as a function of thickness and the calculated values for smooth, continuous films of the indicated thickness. Above about 300 Å, the measured values correspond to the expected values, indicating that the films were contiguous. Below about 150 Å the resistance increased more dramatically with decreasing thickness. This corresponded to a porous, discontinuous film, which was desired. Roughening of the Unity sacrificial polymer's surface through RIE increased the amount of metal that could be sputtered before making a solid layer. In this work, Pt/Ru layers with an average thickness of about 50-200 Å were used as porous, conducting layers on roughened Unity sacrificial polymer.

A titanium adhesion layer was deposited on top of the Pt/Ru before SiO₂ deposition. The amount of Ti needed for adhesion was minimized. About 45 Å (average thickness) of Ti was deposited between Pt/Ru and SiO₂ in the sputtered electrodes.

Sputtering about 600 Å, or approximately 100 μg/cm², of Pt/Ru prior to the deposition and patterning of the Unity sacrificial polymer produced a relatively solid (non-porous) layer on the substrate that increased the total amount of anode catalyst in the cell that could be utilized by a conducting analyte (e.g., acidic methanol). It also seemed to somewhat improve performance with hydrogen. Therefore, all results are discussed herein for cells fabricated with a solid layer of Pt/Ru on the bottom of the microchannels.

The requirements for the proton exchange membrane are different from the traditional PEM (e.g., Nafion) due to the mechanical properties and thickness required in microfabricated fuel cells. Here, SiO₂ is shown to work as a stand-alone membrane. SiO₂ films were deposited by PECVD and the ionic conductivity was measured with impedance spectroscopy at room temperature. FIG. 7 shows the ionic conductivity of silicon dioxide vs. deposition temperature. As the deposition temperature decreased, the conductivity increased due to higher silonol concentration and lower density. The conductivity of the films was much lower than for other commonly used PEMs, such as Nafion, but they are also much thinner than other fuel cell membranes. Extruded Nafion membranes (equivalent weight of 1100) have area resistances of 0.1-0.35 Ω-cm². The area resistance of a 3 μm thick SiO₂ film deposited at 100° C. is 1200 Ω-cm² at room temperature. The relatively high resistance leads to a decrease in cell voltage at higher current. The SiO₂ films used in these devices were adequate to investigate the other parameters, such as the anode and cathode catalyst loading. While they are sufficient for the lower current devices used in this study, improved SiO₂ PEMs are being investigated and will be reported in the future.

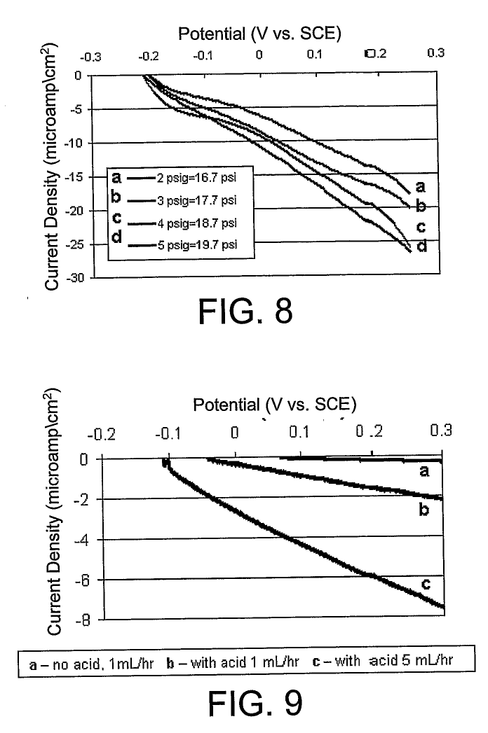

Half-cell devices were fabricated and tested to evaluate the anode performance with different fuels and provide a comparison for the full cell tests. FIGS. 8 and 9 show the half-cell results for hydrogen and methanol, respectively. A solid layer of Pt/Ru was deposited before the sacrificial polymer was patterned, as well as a porous layer on top of the patterned features to be in contact with the membrane. The catalyst weight at the membrane surface was 17 μg/cm².

Hydrogen was supplied with a pressurized tank of ultra high purity grade gas that passed through a bubbler to humidify the feed. FIG. 8 shows the results for inlet pressures of 1-4 psig (15.7-18.7 psia). The current densities of the half-cells scale with the partial pressure of the humidified hydrogen. This indicates that the performance is chiefly limited by the catalytic reaction kinetics at the anode, that is, proportional to hydrogen partial pressure. Further improvements in current density are possible with improved activity of the anode catalyst.

The methanol in water concentration was 1 M. The acidic methanol mixture contained 1 M sulfuric acid with 1 M methanol. FIG. 9 shows the half-cell polarization curves for methanol and acidic methanol. Adding sulfuric acid to the fuel made the solution conductive to protons. The higher active surface area, due to the conductivity of the acidic methanol solution, improved the current density. The Pt/Ru catalyst that was deposited on the walls of the channel not in contact with the membrane was utilized to increase the amount of methanol oxidation. Increasing the flow rate of the acidic methanol fuel improves the current density and open-circuit potential. The main detriment to performance at lower flow rates appears to be the formation of carbon dioxide bubbles at the anode that must be pushed out of the microchannels. With the current densities observed at 0.25 V vs. SCE (2 and 7 mA/cm² for 1 and 5 mL/hr, respectively), the production of gaseous CO₂ bubbles cover catalyst sites and may also restrict the proton conductance through the fuel from the bottom of the microchannels to the PEM.

Microfabricated full-cells were fabricated and tested with linear voltametry at a scan rate of 1 mV/sec from the open-circuit potential. Table 1 compares the differences in process between five sets of cells that are presented here to demonstrate the key parameters (anode and cathode construction) that affect cell performance for these power devices.

TABLE 1
Processing characteristics of micro-fuel cell samples

| | Anode catalyst | SiO₂ membrane | |
|---|---|---|---|
| Sample | weight* (μg/cm²) | thickness (μm) | Cathode catalyst |
| A | 31 | 3.2 | sputtered |
| B | 17 | 3.2 | thick-film |
| C | 34 | 3.2 | thick-film |
| D | 43** | 3.2 | thick-film |
| E | 17 | 2.4 | thick-film |

*Weight at membrane surface (100 μg/cm² at bottom of microchannels)
**Total weight of two Pt/Ru layers with 400 Å SiO₂ deposited between

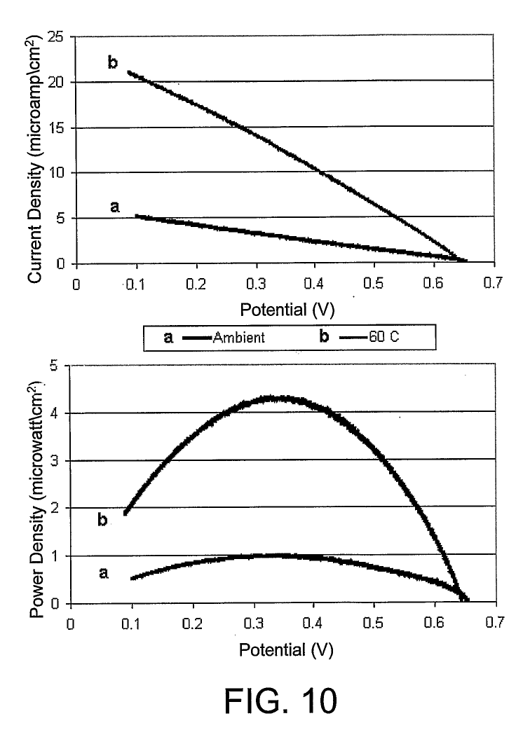

FIG. 10 shows polarization (top) and power (bottom) curves for one cell, sample A, that had sputtered catalyst with a loading of 31 μg/cm² at both the anode and cathode. Humidified hydrogen with an inlet pressure of 1 psig served as the fuel and oxygen from the air was reduced at the cathode. The performance at 60° C. was approximately four times greater than at ambient conditions with a measured peak power density of 4 μW/cm². The lower current densities of these devices with sputtered catalyst on the cathodes compared to the results from the anode half-cells run with hydrogen shown in FIG. 7 demonstrate that their performance is limited by the catalytic activity of the air cathode. This agrees with the expectation that ambient oxygen reduction at the cathode would be performance limiting when pressurized hydrogen was used at the anode.

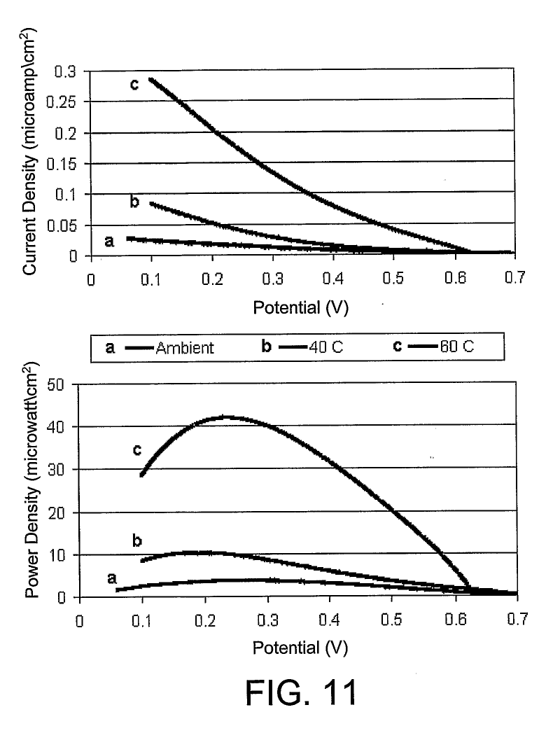

A thick-film ink catalyst was coated onto the air-breathing cathode to improve its area and catalyst activity. When using the painted catalyst ink on top of the membrane, the full cell performance increased dramatically due to the increase in cathode catalyst loading. Because of the significant improvement to the oxygen reduction at the cathode, it was no longer the limiting electrode. The performance of cells with the thick-film cathode was a function of the anode composition. FIG. 11 shows the polarization (top) and power (bottom) curves at ambient temperature, 40° C., and 60° C. for sample B. This sample had an anode and membrane similar to sample A, but used the catalyst ink and porous gold current collector for the cathode. Hydrogen with an inlet pressure of 1 psig was the fuel and the cathode was air-breathing. The room-temperature polarization curve shows current densities very similar to the hydrogen half-cell results from FIG. 7. The performance was approximately one order of magnitude greater than sample A with a peak power density of 42 μW/cm² at 0.23 V and 60° C. These two results indicate that the anode limits the sample's performance when using the painted catalyst instead of the sputtered catalyst at the cathode.

The temperature dependence was such that greater power output could be achieved at elevated temperatures. Waste heat is produced in fuel cells, however, the size of these devices and the amount of power generated suggest that they would not be able to retain enough heat for operation at an elevated temperature. Integrated fuel cells could also use some heat released from the circuit (or other electronic devices) that they are built on.

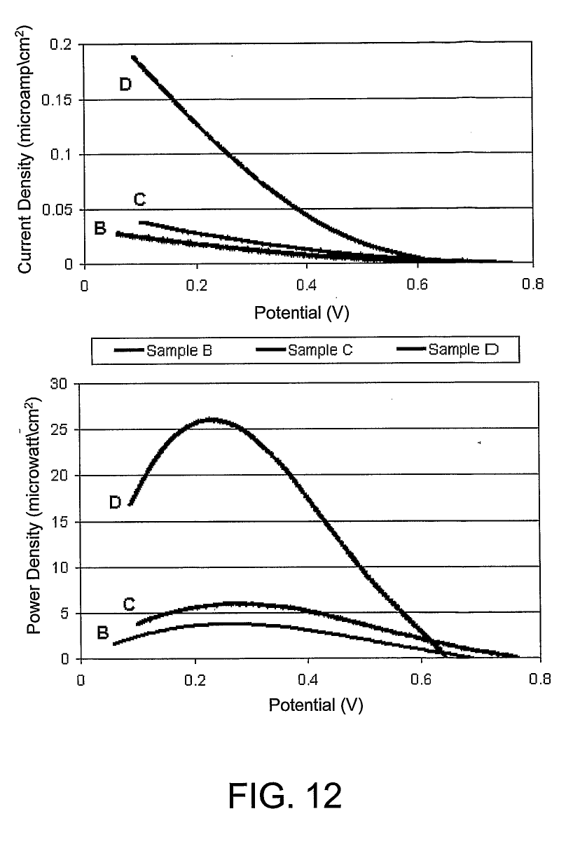

Improvements in the activity and surface area of the anode can lead to higher currents and power densities. The anode performance was improved with a higher catalyst loading. FIG. 12 shows the room temperature polarization (top) and power (bottom) curves of three samples with different amounts of sputtered catalyst at the anode. Humidified hydrogen with an inlet pressure of 1 psig was the fuel and the thick-film cathodes were air-breathing. A solid layer of approximately 100 μg/cm² of Pt/Ru was deposited on the bottom of the microchannels on each sample. At the membrane surface, sample B had 17 μg/cm² of Pt/Ru and sample C had 34 μg/cm². With twice as much sputtered Pt/Ru at the membrane, sample C shows an improvement in performance of less than 50% over sample B. Sputtering twice as much Pt/Ru does not double the catalyst surface area because the deposited islands are getting bigger, forming a more continuous (less porous) film.

To improve the electrode performance, the catalyst surface area, particularly the catalyst that is in direct contact with the electrolyte, must be increased. A thin layer of SiO₂ electrolyte could be deposited between two catalyst depositions because it was deposited through PECVD. Sample D had the same 34 μg/cm² layer as C deposited on the patterned sacrificial polymer, followed by a deposition of 400 Å of SiO₂, and then an additional 8.5 μg/cm² of catalyst, before the thicker SiO₂ PEM layer was deposited. The second layer of sputtered Pt/Ru was embedded in SiO₂, increasing the catalyst/electrolyte contact area. With only 25% more Pt/Ru at the membrane, the peak power density of sample D was over four times greater than sample C at room temperature. This dramatic improvement in current and power density was due to the SiO₂-encapsulated layer of Pt/Ru that allowed for more membrane/catalyst contact in addition to the increase in total catalyst weight. The two thin layers of Pt/Ru and the small amount of SiO₂ between them most likely form a mixed matrix of catalyst and electrolyte that is conductive to both protons and electrons while increasing the overall catalyst surface area, particularly the area in contact with the electrolyte.

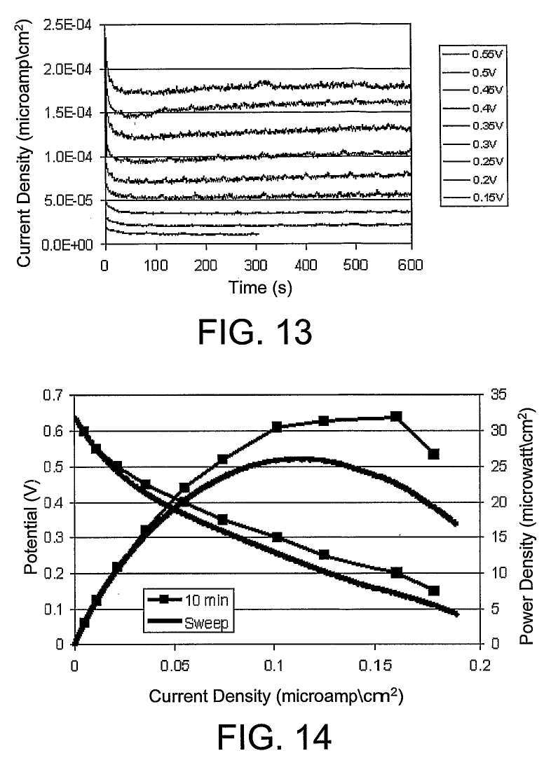

The performance of the hydrogen fuel cells was studied as a function of time to determine if the data collected through linear voltametry matches steady-state values at constant potential. FIG. 13 shows the current density of sample D when a constant potential is held for ten minutes. The data show a relatively constant performance that is very close to the values collected for a linear sweep of 1 mV/s, as shown in FIG. 14. Tests over longer periods of time, such as a few hours, with different devices have shown similar results. The SiO₂ did not swell with water like Nafion films, making them less susceptible to changes with time, such as a drop in performance from drying out.

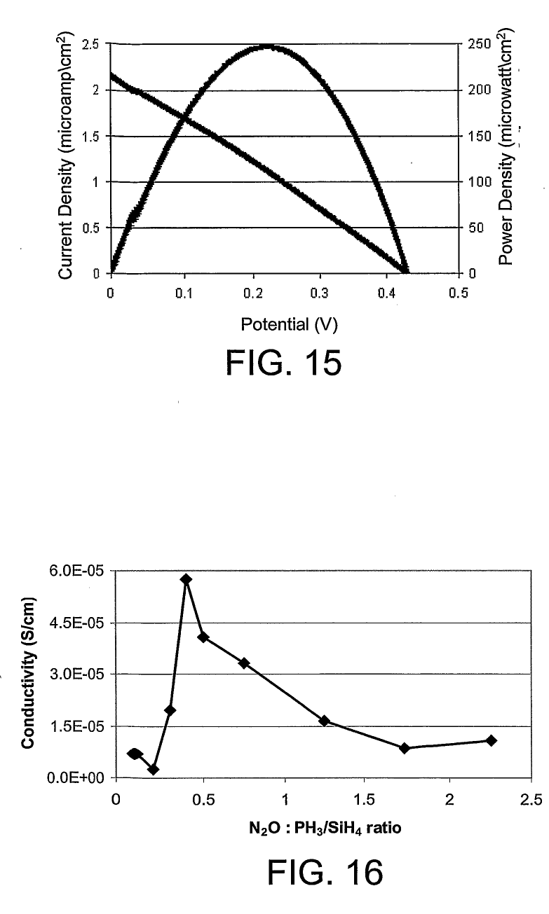

FIG. 15 shows the polarization and power curve for the acidic methanol solution run at room temperature with a flow rate of 1 mL/hr in sample E, a microchannel full cell with the thick-film cathode. The solid layer of catalyst at the bottom of the microchannel is utilized in addition to the porous Pt/Ru at the membrane in the oxidation of methanol because the fuel solution can conduct protons. While the open-circuit potential is lower than when using hydrogen, the peak current and power densities are much higher than the same device with hydrogen as the fuel.

The experiments have shown trends that are being used to further enhance the performance of microfabricated fuel cells. Adding catalyst to the bottom of microchannels is an effective technique for use with conductive fuels. However, increasing the catalyst at the membrane through the use of multiple SiO₂ embedded layers to maintain porosity shows promise for increased current density.

Additional areas of ongoing study include other improvements to the electrodes, such as increased anode area, and membrane properties, especially conductivity. Reducing the thickness of SiO₂ would decrease the resistance of the PEM, but the mechanical strength must be maintained to avoid fuel cells breaking from the pressure of the fuel in the anode microchannels.

### CONCLUSIONS

Micro-fuel cells utilizing sacrificial polymer-based microchannels and thin-film SiO₂ membranes have been successfully fabricated and tested. Low-temperature PECVD silicon dioxide shows promise for use in integrated thin-film devices. Lowering the deposition temperature dramatically increased the conductivity of the films to an acceptable level for the current densities achieved with the fabricated electrodes used in this study.

Repeated alternate catalyst sputtering and SiO₂ deposition steps to build up a catalyst matrix will provide an electrode with increased catalyst and membrane-catalyst contact area. Additional catalyst that is not in contact with the membrane can be utilized when using a conductive analyte, such as acidic methanol.

### EXAMPLE 2

Microfabricated fuel cells have been designed and constructed on silicon integrated circuit wafers using many processes common in integrated circuit fabrication, including sputtering, polymer spin coating, reactive ion etching, and photolithography. Phosphorous-doped silicon dioxide has been studied as a proton exchange membrane for use in these thin-film fuel cells. It is deposited through plasma-enhanced chemical vapor deposition (PECVD) and has ionic conductivities two orders of magnitude greater than low-temperature deposited SiO₂ previously used in microfabricated cells. Films with a thickness of 6 μm and a resistivity of 100 kΩ-cm have an area resistance of 60 Ω-cm², which compares favorably to a 175 μm-thick film on Nafion 117. The use of phosphorous-doped SiO₂ in the microfabricated fuel cells has improved the performance over previous cells that used un-doped silicon dioxide.

### Experimental Method

A schematic cross section of the microfabricated fuel cells is similar to that shown in FIG. 3A. The materials and processes used to fabricate the thin-film fuel cells have been previously disclosed. Unity 2000P (Promerus LLC, Brecksville, Ohio) was used as the sacrificial polymer to form the microchannel structures. The catalyst layers were sputter deposited using a CVC DC sputterer (CVC Products, Inc., Rochester, N.Y.). A 50:50 atomic ratio platinum/ruthenium target (Williams Thin-Film Products, Brewster, N.Y.) was used as the source target.

The deposition of SiO₂ took place in a PECVD system at temperatures of about 75-250° C. The reactant gases were silane and nitrous oxide with an operating pressure of about 600 mTorr. Phosphorous-doped silicon dioxide (P—SiO₂) was deposited by substituting a gas mixture of 0.3% phosphine and 5.0% silane in helium carrier gas for the standard silane gas (5.0% SiH₄ in He). Typically, the ratio of the flow rates of N₂O to PH₃/SiH₄ (or N₂O to SiH₄) was 2.25 and the operating temperature 100° C. These values were varied one parameter at a time, while keeping other parameters the same. Film thicknesses were measured with an Alpha-Step surface profilometer (KLA-Tencor, San Jose, Calif.) after using a physical mask to prevent deposition on in a selected region on the substrate. Un-doped SiO₂ PEM layers used in previous fuel cell devices (data from some of which are shown for comparison) were deposited using a Plasma-Therm PECVD system (Plasma-Therm, St. Petersburg, Fla.) at 100° C. and the other parameters the same.

Fourier transform infrared (FTIR) spectroscopy was performed using a Nicolet model 560 and Omnic software. All electrochemical measurements, including impedance spectroscopy (IS) and linear voltamagrams, were performed with a PerkinEkner PARSTAT 2263 (EG&G, Princeton, N.J.) electrochemical system. The scan rate for linear sweep voltametry was 1 mV/s. Hydrogen was supplied to the anode microchannels through fine tubing from a pressurized tank of ultra high purity grade gas that passed through a bubbler to humidify the feed. Ionic conductivity was measured with impedance spectroscopy through SiO₂ films deposited onto aluminum-coated substrates and contacted with a mercury probe, as well as with actual cells. The frequency range for the impedance measurement was from 100 mHz to 1 MHz, with an AC signal amplitude of 10 mV.

### Results and Discussion

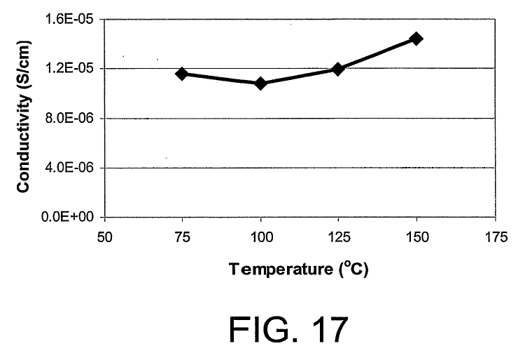

SiO₂ and phosphorous-doped SiO₂ (P—SiO₂) films were deposited onto aluminum-coated glass slides with thicknesses of 1.4-1.5 μm. P—SiO₂ films on the aluminum-coated substrates were measured for ionic conductivity through the use of impedance spectroscopy (IS). FIGS. 16 and 17 show the effect of two parameters, temperature and gas ratio, on the conductivity. The data for FIG. 16 was from samples deposited at 100° C. and 400 W power; with only gas flow rates changed. By decreasing the ratio of N₂O to PH₃/SiH₄ from the standard 2.25 to 1 to 0.5, the conductivity increased until the ratio is only 0.5.

FIG. 17 shows that the conductivity of P—SiO₂ was not as dependent upon deposition temperature as the original SiO₂ films. These films were deposited with the standard gas ratio of 2.25 and 400 W power. This provides good evidence that the conduction of ions through the P—SiO₂ was improved due to the phosphorous and not just an increase in silanol concentration with decreased temperature. The amount of phosphorous should not change dramatically due to deposition temperature. Because of the low decomposition temperature of the PPC sacrificial polymer, 100° C. continued to be used for the deposition of P—SiO₂ in the fuel cell devices.

While a dramatic increase compared to un-doped SiO₂, the conductivity of the P—SiO₂ films remains lower than for other commonly used PEMs, such as Nafion, but they are also much thinner than other fuel cell membranes. Extruded Nafion membranes (equivalent weight of 1100) have area resistances of 0.1-0.35 Ω-cm² (15). The area resistance of a 3 μm thick P—SiO₂ film deposited at 100° C. is 30 Ω-cm² at room temperature. The relatively high resistance leads to a decrease in cell voltage at higher current.

P—SiO₂ films were used as PEMs in microfabricated fuel cells to compare to the un-doped SiO₂. Again, the deposition temperature of the PECVD chamber was 100° C. Although, many different recipes were tested for ionic conductivity measurements, the mechanical strength of the films using some of the different gas ratios were not as good as the standard SiO₂ recipe. For this reason, the initial fuel cell devices with phosphorous doping used the standard recipe with only the phosphine-silane gas substituted for silane. These films, however, were still not as strong as the previous SiO₂ films and required a thicker deposition.

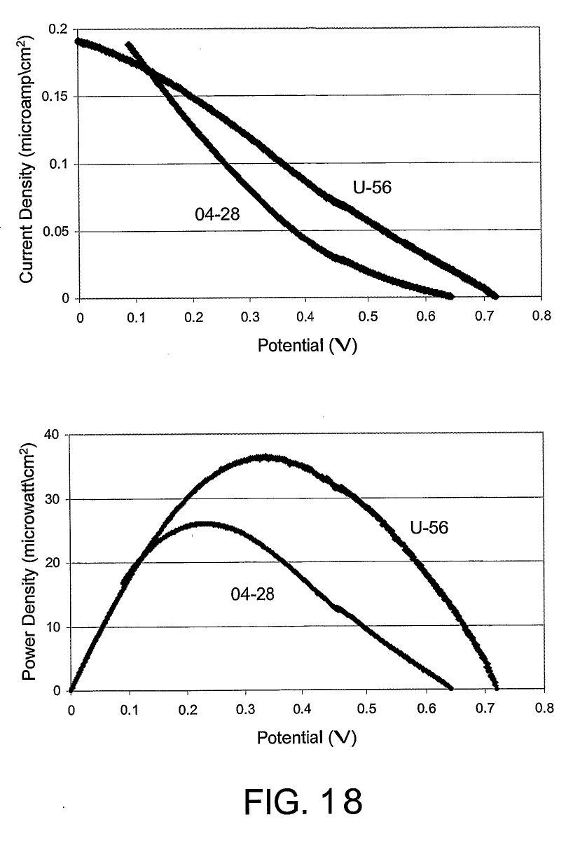

Microfabricated full-cells were fabricated using the processes previously described and tested with linear voltametry at a scan rate of 1 mV/sec from the open-circuit potential. A 6-μm thick P-doped SiO₂ was successfully used as a PEM in the devices. FIG. 18 shows the polarization and power curves for a cell, U-56, with 150 Å of Pt/Ru at the membrane surface and a thick-film cathode. Humidified hydrogen with an inlet pressure of 1 psig served as the fuel and the cathode was air breathing. The results, shown in blue, are plotted alongside the results from the 250 Å Pt/Ru, double catalyst layer sample (04-28, shown in maroon) previously discussed. The open-circuit potential of 720 mV was almost 70 mV higher. This was most likely due to the thicker PEM, which would have had a positive impact on fuel crossover and electrical isolation. Because the ionic conductivity was higher than un-doped SiO₂, the current density does not appear to have been diminished due to the thicker membrane. Despite the fact that the doped sample had less total catalyst, which was from one deposition at the surface, its peak power density of 36 μW/cm² was almost 40% greater than the other sample. Both of the samples' peak power densities came at approximately 1 mA/cm², but the voltage of the doped sample was about 100 mV at this current.

### CONCLUSIONS

The addition of phosphorous to SiO₂ has been shown to increase the ionic conductivity of the films and improve the overall performance of microfabricated fuel cells when used as the PEM. The conductivity of P—SiO₂ films deposited under the same process conditions as the previously used SiO₂ membranes, except the addition of the phosphine gas, was approximately 50 times greater than the un-doped low-temperature SiO₂. Due to this increase in conductivity, thicker PEM layers could be deposited to improve the mechanical strength of the devices while still having a lower resistance to proton transport. The thicker films also improved the open-circuit potential, leading to better overall performance. The P—SiO₂ sample outperformed all un-doped SiO₂ samples, including ones with better anodes. P—SiO₂ proved to be the preferred thin-film PEM material for these devices.

It should be emphasized that the above-described embodiments of this disclosure are merely possible examples of implementations, and are set forth for a clear understanding of the principles of this disclosure. Many variations and modifications may be made to the above-described embodiments of this disclosure without departing substantially from the spirit and principles of this disclosure. All such modifications and variations are intended to be included herein within the scope of this disclosure and protected by the following claims.

Therefore, the following is claimed:

1. A fuel cell, comprising:
a membrane comprising a material selected from organic conducting materials, inorganic conducting materials, and combinations thereof, wherein the membrane has a thickness of about 0.01 to 10 μm, and wherein the membrane has an area resistivity of about 0.1 to 1000 ohms cm².

2. The fuel cell of claim 1, wherein the membrane has a thickness of about 0.1 to 5 μm.

3. The fuel cell of claim 1, wherein the membrane has a thickness of about 0.1 to 2 μm.

4. The fuel cell of claim 1, wherein the membrane has an area resistivity of about 1 to 100 ohms cm².

5. The fuel cell of claim 1, wherein the membrane has an area resistivity of about 1 to 10 ohms cm².

6. The fuel cell of claim 1, wherein the material is selected from silicon dioxide, doped silicon dioxide, silicon nitride, doped silicon nitride, silicon oxynitride, doped silicon oxynitride, metal oxides, doped metal oxides, metal nitrides, doped metal nitrides, metal oxynitrides, doped metal oxynitrides, and combinations thereof.

7. The fuel cell of claim 6, wherein the doped silicon dioxide is selected from phosphorous doped silicon dioxide, boron doped silicon dioxide, and combinations thereof.

8. The fuel cell of claim 1, further comprising a catalyst disposed on a first side of the membrane, wherein the catalyst is selected from platinum, platinum/ruthenium, nickel, tellurium, titanium, alloys of each, and combinations thereof.

9. The fuel cell of claim 8, further comprising a polymer layer on a second side of the membrane, wherein the polymer layer has a catalyst disposed on the side opposite the membrane.

10. The fuel cell of claim 1, wherein the membrane has a thickness of about 0.1 to 2 μm and wherein the membrane has an area resistivity of about 1 to 10 ohms cm².

11. A micro-fuel cell, comprising:
a substrate having anode current collectors disposed thereon;
a membrane disposed on the anode current collectors, wherein the membrane comprises a material selected from silicon dioxide, doped silicon dioxide, silicon nitride, doped silicon nitride, silicon oxynitride, doped silicon oxynitride, metal oxides, doped metal oxides, metal nitrides, doped metal nitrides, metal oxynitrides, doped metal oxynitrides, and combinations thereof,
wherein the membrane has a thickness of about 0.01 to 10 μm, and wherein the membrane has an area resistivity of about 0.1 to 1000 ohms cm²;
a hollow channel substantially defined by a portion of the substrate and a portion of the membrane, wherein at least one catalyst layer is exposed to the channel, wherein the anode current collector is disposed adjacent the channel;
a cathode current collector disposed on the membrane on the side opposite the substrate;
wherein there is an electrically conductive path between the catalyst layer and the anode current collector.

12. The micro-fuel cell of claim 11, wherein the catalyst layer comprises a first porous catalyst layer disposed on a first side of the membrane facing the substrate, wherein the first porous catalyst layer is exposed within the channel, wherein there is an electrically conductive path between the first porous catalyst layer and the anode current collector.

13. The micro-fuel cell of claim 12, wherein the catalyst layer is disposed on the substrate exposed within the channel, wherein there is an electrically conductive path between the catalyst layer, the first porous catalyst layer, and the anode current collector.

14. The micro-fuel cell of claim 11, wherein the catalyst layer comprises a catalyst layer disposed on the substrate exposed within the channel, wherein there is an electrically conductive path between the catalyst layer and the anode current collector.

15. The micro-fuel cell of claim 11, further comprising a second porous catalyst layer disposed on the membrane on the side opposite the substrate, wherein there is an electrically conductive path between the cathode current collector and the second porous catalyst layer.

16. The micro-fuel cell of claim 15, further comprising a polymer layer disposed on the side of the membrane opposite the substrate, wherein the cathode current collector and the second porous catalyst layer are disposed on the polymer layer.

17. The micro-fuel cell of claim 16, wherein the polymer layer is selected from perfluorosulfonic acid/polytetrafluoroethylene copolymer, polyphenylene sulfonic acid, modified polyimide, and combinations thereof.

18. The micro-fuel cell of claim 11, wherein the catalyst layer includes catalysts selected from platinum, platinum/ruthenium, nickel, tellurium, titanium, alloys thereof, and combinations thereof.

19. The micro-fuel cell of claim 11, wherein the wherein the membrane has a thickness of about 0.1 to 5 μm and wherein the membrane has an area resistivity of about 1 to 100 ohms cm².

20. A method for fabricating a micro-fuel cell, comprising:
providing a substrate having an anode current collector disposed thereon;
disposing a sacrificial polymer layer onto the substrate and the anode current collector;
removing portions of the sacrificial material not disposed on the anode current collector to form sacrificial material portions;
disposing a first porous catalyst layer onto the sacrificial material portions;
disposing a layer of a membrane material onto the sacrificial material portions, the first porous catalyst layer, and the anode current collector, wherein the membrane material is selected from silicon dioxide, doped silicon dioxide, silicon nitride, doped silicon nitride, silicon oxynitride, doped silicon oxynitride, metal oxides, doped metal oxides, metal nitrides, doped metal nitrides, metal oxynitrides, doped metal oxynitrides, and combinations thereof; and
removing the sacrificial material portions to form hollow channels substantially defined by the substrate, membrane material, and the first porous catalyst layer.

21. The method of claim 20, further comprising:
disposing a second porous catalyst layer onto a top portion of the membrane material on the opposite side of the membrane material as the substrate; and
disposing a cathode current collector onto portions of the second porous catalyst layer.

22. The method of claim 20, further comprising:
disposing a polymer layer onto the membrane material;
disposing a second porous catalyst layer onto a top portion of the polymer layer on the opposite side of the polymer layer as the membrane layer; and
disposing a cathode current collector onto portions of the second porous catalyst layer.

23. The method of claim 20, wherein the polymer layer is selected from perfluorosulfonic acid/polytetrafluoroethylene copolymer, polyphenylene sulfonic acid, modified polyimide, and combinations thereof.

24. The method of claim 20, further comprising:
providing a catalyst layer on portions of the substrate, wherein the catalyst layer is disposed on portions of the substrate between the sacrificial material portions and the substrate.

25. The method of claim 20, wherein the sacrificial material is selected from polyimides, polynorbornenes, epoxides, polyarylenes ethers, polyarylenes, inorganic glasses, and combinations thereof.

26. A method for fabricating a micro-fuel cell, comprising:
providing a substrate having an anode current collector disposed thereon and a catalyst layer disposed thereon, wherein the anode current collector and the catalyst layer are adjacent one another;
disposing a sacrificial polymer layer onto the substrate, the anode current collector, and the catalyst layer;
removing portions of the sacrificial material not disposed on the anode current collector to form sacrificial material portions disposed on the catalyst layer;
disposing a layer of a membrane material onto the sacrificial material portions and the anode current collector, wherein the membrane material is selected from silicon dioxide, doped silicon dioxide, silicon nitride, doped silicon nitride, silicon oxynitride, doped silicon oxynitride, metal oxides, doped metal oxides, metal nitrides, doped metal nitrides, metal oxynitrides, doped metal oxynitrides, and combinations thereof; and
removing the sacrificial material portions to form hollow channels substantially defined by the substrate, membrane material, and the catalyst layer.

27. The method of claim 26, further comprising:
disposing a first porous catalyst layer onto the sacrificial material portions prior to disposing the membrane material.

28. The method of claim 26, further comprising:
disposing a second porous catalyst layer onto a top portion of the membrane material on the opposite side of the membrane material as the substrate; and
disposing a cathode current collector onto portions of the second porous catalyst layer.

29. The method of claim 26, further comprising:
disposing a polymer layer onto the membrane material;
disposing a second porous catalyst layer onto a top portion of the polymer layer on the opposite side of the polymer layer as the membrane layer; and
disposing a cathode current collector onto portions of the second porous catalyst layer.

30. The method of claim 26, wherein the polymer layer is selected from perfluorosulfonic acid/polytetrafluoroethylene copolymer, polyphenylene sulfonic acid, modified polyimide, and combinations thereof.
